(19) United States
(12) Patent Application Publication
(10) Pub. No.: US 2009/0220766 A1
(43) Pub. Date: Sep. 3, 2009

(54) LIGHTWEIGHT COMPOSITE PANEL

(75) Inventors: MICHAEL FARRELL, CALEDONIA, MI (US); GREGORY R. FINSES, JENISON, MI (US); MICHAEL J. PETERSON, WYOMING, MI (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: L & P PROPERTY MANAGEMENT COMPANY, SOUTH GATE, CA (US)

(21) Appl. No.: 12/041,232

(22) Filed: Mar. 3, 2008

(51) Int. Cl. B32B 7/12; B29C 43/20

(52) U.S. Cl. 428/317.5; 264/319; 264/494; 428/411.1

(57) ABSTRACT

This invention is related to a lightweight composite panel and a method of making the same. The lightweight composite panel is used in the construction of cabinets and furnishings where weight must be kept to a minimum. The lightweight composite panel includes a top skin panel, at least one core frame, a bottom skin panel, and a lightweight material. The core frame is assembled from flat members that form the perimeter of the lightweight composite panel, while the top and bottom skin panel form the planar sides of the panel. The lightweight material is shaped to fill the cavity created by the top and bottom skin panels and the core frame. The components of the lightweight composite panel are pressed between corresponding mold halves, thereby taking the shape of the mold halves and forming a contoured lightweight composite panel that has the appearance of a traditional solid panel.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates to a lightweight composite panel for use in furnishings and cabinets (collectively referred to as “furnishings”) in applications where the weight of the furnishings is a chief design concern. These applications are as varied as recreational vehicles, boats and aircraft. Common to all of the applications is a requirement that the weight of furnishings be kept to a minimum, without sacrificing the aesthetic appearance of the furnishings. As the panels that form the furnishings account for the majority of the weight of the furnishings, the greatest weight savings are realized by reducing the weight of the panels.

Various designs for lightweight furnishings are known. Some known designs are composed of panels made of aluminum or synthetic materials such as various plastics. While these designs are lightweight in nature, they lack a visually appealing aesthetic appearance. Solid wood panels provide the desired aesthetically pleasing visual appearance, but the panels have a substantial weight, thus failing to meet the requirements for a lightweight furnishing.

Consequently, what is needed is a lightweight composite panel that has an aesthetically pleasing visual appearance, but is lightweight in nature so as to be suitable for applications where weight is to be kept to a minimum, and is easily manufactured with efficient use of materials and labor.

### BRIEF SUMMARY OF THE INVENTION

A brief overview of the lightweight composite panel and its method of manufacture follows immediately below. A more detailed description is provided in the Detailed Description of the Invention section.

The present invention provides a lightweight composite panel and a method of manufacturing the same.

The lightweight composite panel broadly includes, a top skin panel, a bottom skin panel, a core frame layer, and a lightweight material. The core frame layer is composed of a plurality of flat members that when assembled form a bounded, two-dimensionally enclosed area. A core of lightweight material of equal thickness to the core frame, and of substantially similar length and width of the bounded two dimensional area is situated within the enclosed area. An adhesive is applied to the surfaces of each layer and core. The assembly is then placed into a press that has two die halves. The assembly is pressed between the two die halves, forming the desired contour of the panel. The top and bottom skin panels, core frame layer, and core of lightweight material are therefore bonded together in a single molding and shaping process.

The lightweight composite panel has the appearance of a conventional solid wood panel, but weighs substantially less than a solid wood panel of similar dimensions. In addition, the lightweight material core provides structural rigidity and sound dampening to what would otherwise be a hollow cavity. The lightweight composite panel described herein provides a significant improvement over prior designs for lightweight panels by providing a look and feel that is nearly identical to a solid wood panel. The method of manufacturing the lightweight composite panel described is a simple and efficient process that forms the panel in a single molding process, thereby reducing labor costs and manufacturing time.

As will be seen from the detailed description that follows, the invention provides a lightweight composite panel and method of manufacturing the same. Additional advantages, and novel features of the invention will be set forth in part in a description which follows and in part will become apparent to those skilled in the art upon examination of the following, or may be learned by practice of the invention.

### BRIEF DESCRIPTION OF THE SEVERAL VIEWS OF THE DRAWING

In the accompanying drawings, which form a part of the specification, and which are to be read in conjunction therewith, and in which like reference numerals are used to indicate like parts in the various views, where thicknesses and dimensions of some components may be exaggerated for clarity:

FIG. 1 is an exploded view of the components of a lightweight composite panel, according to an embodiment of the present invention;

FIG. 2 is a perspective view of the assembled components of a lightweight composite panel prior to being formed in a press, in accordance with an embodiment of the present invention;

FIG. 3 is a section view of FIG. 2, in accordance with an embodiment of the present invention;

FIG. 4 is an exploded cross section view of the components of a lightweight composite panel positioned in a press, prior to forming, in accordance with an embodiment of the present invention;

FIG. 5 is a perspective view of the lightweight composite panel, after the forming operation has been performed in the press, in accordance with embodiments of the present invention; and

FIG. 6 is a section view of FIG. 5, according to an embodiment of the present invention.

### DETAILED DESCRIPTION OF THE INVENTION

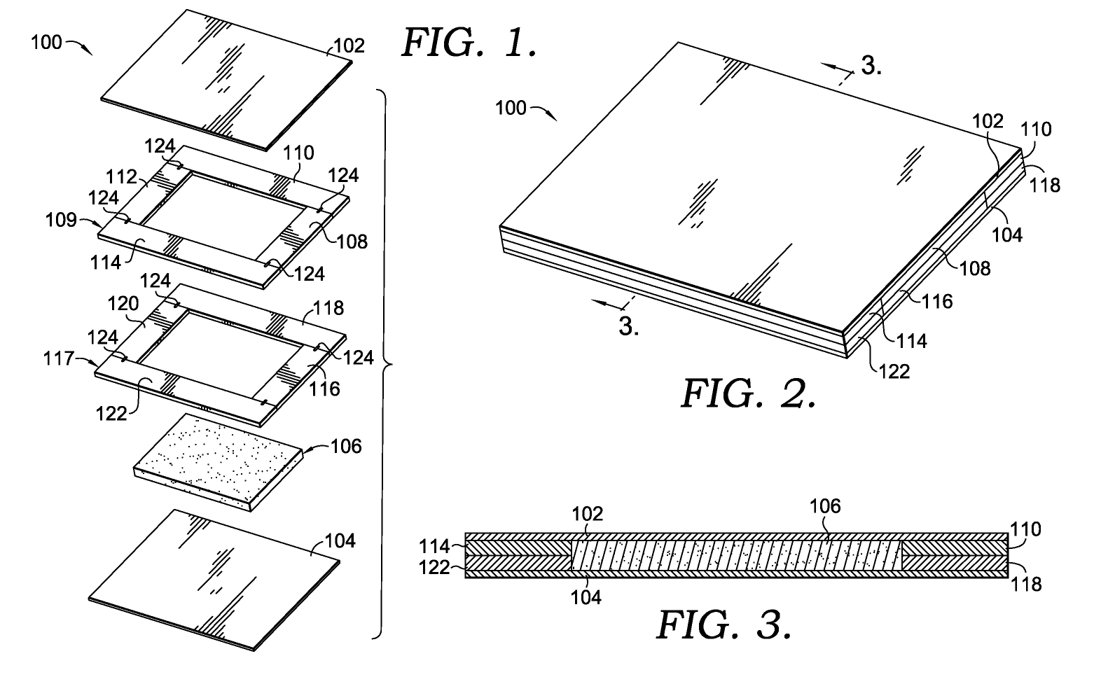

Referring to the drawings in greater detail and initially to FIG. 1, the embodiments of the present invention are directed toward a lightweight composite panel, which is shown and designated generally by reference numeral 100. The components of a lightweight composite panel 100 include a top skin panel 102, a bottom skin panel 104, a lightweight material 106, a first core frame 109, and a second core frame 117. Alternative embodiments of the invention may include only one core frame or more than two core frames.

The components mentioned above will now be discussed with more detail, with reference to FIG. 1. In one embodiment, the first core frame 109 is composed of a first flat member 108, a second flat member 110, a third flat member 112, and a fourth flat member 114. In one embodiment, the flat members 108, 110, 112, 114 are of substantially similar thickness and constructed of substantially similar materials. The first flat member 108 and the third flat member 112 are of substantially similar length and width. The second flat member 110 and the fourth flat member 114 are also of substantially similar length and width.

The second core frame 117 is composed of a first flat member 116, a second flat member 118, a third flat member 120, and a fourth flat member 122. In one embodiment, the flat members 116, 118, 120, 122 are of substantially similar thickness and constructed of substantially similar materials. The first flat member 116 and the third flat member 120 are of substantially similar length and width. The second flat member 118 and the fourth flat member 122 are also of substantially similar length and width. Although not depicted in the figures, in alternative embodiments the core frame may be constructed from a single flat member, with the interior portion removed, resulting in a core frame of substantially similar dimensions as one assembled from a plurality of flat members

The materials used to construct the first core frame 109 and the second core frame 117 are selected from traditional sawn lumber, plywood, oriented strand board, synthetic materials such as plastics, or any other material possessing a similar rigidity as the previously mentioned materials, yet still flexible enough to be pressed into a contoured shape.

As depicted in FIG. 1, the flat members 108, 110, 112, 114 comprising the first core frame 109 are fastened together at each of their joints with a fastening means 124. The flat members 116, 118, 120, 122 comprising the second core frame 117 are also fastened together at each of their joints with a fastening means 124. The fastening means 124 may comprise a staple, a nail, a threaded fastener, an adhesive, or any other fastening means known to one skilled in the art. Although depicted in FIG. 1 as being rectangular in overall shape, the first core frame 109 and the second core frame 117 may take other overall shapes in alternative embodiments of the invention. In alternative embodiments of the invention, the first core frame 109 and the second core frame 117 may be circular, trapezoidal, octagonal, or triangular in overall shape. These shapes are provided as examples, and are not meant to be limiting in nature. Additionally, although not depicted in FIG. 1, cross members similar in dimension to the flat members 112, 108 may be added to the first core frame 109 and second core frame 117 to increase structural rigidity and provide additional support for larger core frames. In embodiments of the invention that utilize cross members, the multiple pieces of the lightweight material 106 will be formed in the shape of the respective enclosed areas created by the cross members and the other flat members of the first core frame 109 and second core frame 117.

In the embodiment depicted in FIG. 1, the first core frame 109 and the second core frame 117 are utilized in the lightweight composite panel 100. The first core frame 109 and the second core frame 117 are of substantially similar length and width, although they may differ in overall thickness. Although not depicted in FIG. 1, in an alternative embodiment additional core frames similar in construction to the first core frame 109 and second core frame 117 may be used in the construction of the lightweight composite panel 100. In another alternative embodiment, only one core frame, such as the first core frame 109, may be utilized in the construction of the lightweight composite panel 100.

As depicted in FIG. 1, the top skin panel 102 and bottom skin panel 104 are of substantially similar length, width and thickness. In an alternative embodiment, the thickness of the top skin panel 102 and the bottom skin panel 104 may be dissimilar The top skin panel 102 and the bottom skin panel 104 may be constructed of traditional sawn lumber, a wood veneer, or layers of wood veneer bonded together to form a single top skin panel 102 or bottom skin panel 104. In another embodiment of the invention, the top skin panel 102 and bottom skin panel 104 may be constructed of synthetic or man-made materials. Additionally, as the bottom skin panel 104 is the surface most likely to be seen on a regular basis by an end user once the bottom skin panel 104 is incorporated into a furnishing, a higher grade or quality material may be used for the bottom skin panel 104, while a lower grade or quality material may be used for the top skin panel 102. The use of a lower grade or quality material for the top skin panel 102 would reduce the overall cost of the lightweight composite panel 100, without any reduction in perceived quality or functionality by the end user. Although not depicted in FIG. 1, in other embodiments of the invention an additional panel, similar in length and width to that of the top skin panel 102 or bottom skin panel 104, may be inserted in between the top skin panel and first core frame 109 or the bottom skin panel 104 and second core frame 117. In embodiments of the invention that utilize this additional panel, the top skin panel 102 may not be as thick as the additional panel placed between the top skin panel 102 and the first core frame 109. Accordingly, in embodiments of the invention that utilize an additional panel between the bottom skin panel 104 and the second core frame 117, the bottom skin panel 104 may not be as thick as the additional panel. In an additional embodiments of the invention, additional panels may be utilized under both the top skin panel 102 and bottom skin panel 104.

The lightweight material 106 depicted in FIG. 1 is of substantially similar length and width of the enclosed area created by the first core frame 109 and the second core frame 117. The lightweight material 106 is of substantially similar thickness as the combined thickness of the first core frame 109 and the second core frame 117. In another embodiment, the lightweight material would be equal in thickness to a plurality of first core frames 109, or the thickness of a single first core frame 109. The lightweight material 106 is therefore shaped so as to occupy the cavity that would otherwise be created when the top skin panel 102, first core frame 109, second core frame 117, and bottom skin panel 104 are assembled. The lightweight material 106 may be formed from a polystyrene foam or any other material that is similar in density and rigidity to polystyrene and similarly rigid in nature. In one embodiment, the lightweight material 106 may be expanded polystyrene foam.

Turning to FIG. 2, a depiction is presented of a perspective view of the assembled components of the lightweight composite panel 100 prior to being formed in a press 126, in accordance with an embodiment of the present invention. The top skin panel 102 and the bottom skin panel 104 are positioned on the exterior of the lightweight composite panel 100. In one embodiment, the components of the lightweight composite panel 100 are arranged such that the second core frame 117 is positioned atop the bottom skin panel 104, the first core frame 109 is positioned atop the second core frame 117, the lightweight material 106 is placed in the area enclosed by the bottom skin panel 104 and the first and second core frames 109 117, and the top skin panel 102 is placed atop the first core frame 109 and lightweight material 106.

FIG. 3 depicts a cross-sectional view of the assembled components of the lightweight composite panel 100 prior to being formed in the press 126. As the view depicted is a cross-sectional view, the second flat member 110 and fourth flat member 114 of the first core frame 109 are shown, and the second flat member 118 and fourth flat member 122 of the second core frame 117 are shown. The top skin panel 102 and the bottom skin panel 104 are also visible in FIG. 3.

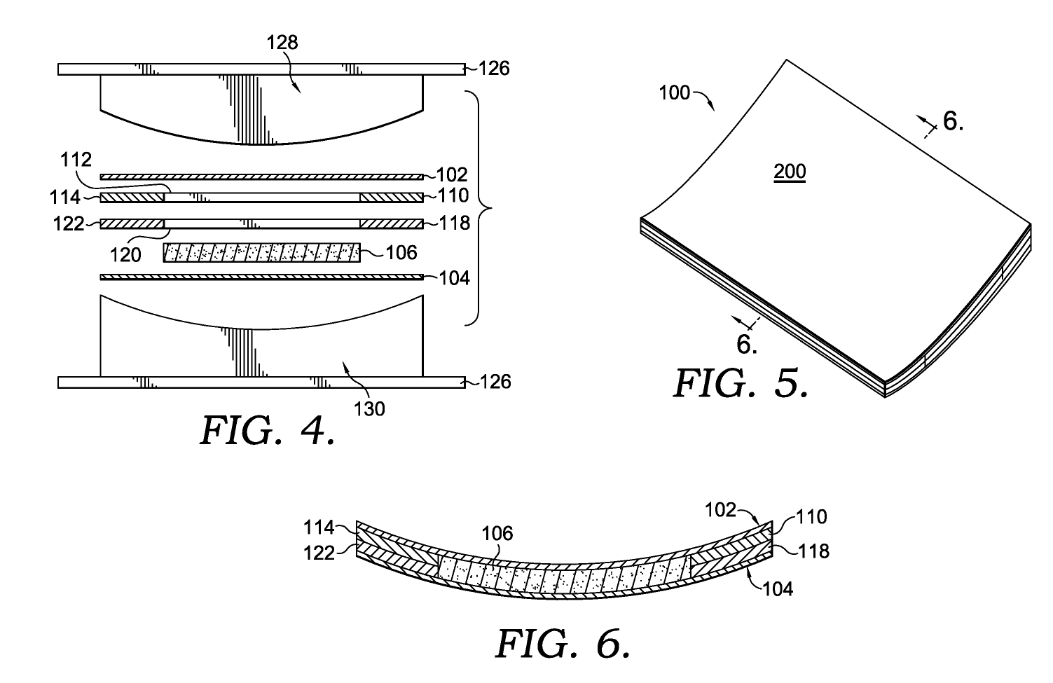

FIG. 4 is a cross-sectional exploded view of the components of a lightweight composite panel 100 positioned in a press, prior to forming, in accordance with an embodiment of the present invention. The press 126 comprises a mold base 130 and an upper mold half 128. FIG. 4 will be described in greater detail when the method of manufacturing the lightweight composite panel 100 is described in detail below.

FIG. 5 is a perspective view of the lightweight composite panel 100, after the forming operation has been performed in the press 126, in accordance with an embodiment of the present invention. As can be seen in FIG. 5, the lightweight composite panel 100 takes the contour of the mold base 130 and upper mold half 128 after the forming operation in the press 126.

FIG. 6 is a section view of FIG. 5, according to an embodiment of the present invention. The contour of the lightweight composite panel 100 is readily apparent. As the view depicted is a cross-sectional view, the second flat member 110 and fourth flat member 114 of the first core frame 109 are shown, and the second flat member 118 and fourth flat member 122 of the second core frame 117 are shown. The top skin panel 102 and the bottom skin panel 104 are also visible in FIG. 6.

The method of manufacturing the lightweight composite panel 100 will now be described, as performed in one embodiment of the invention. The method commences with the assembling of the first core frame 109 from the first flat member 108, the second flat member 110, the third flat member 112, and the fourth flat member 114. The flat members 108 110 112 114 comprising the first core frame 109 are fastened together by way of a fastening means 124. The fastening means 124 may comprise a staple, an adhesive, a nail, a threaded fastener, or any other fastening means that is known to one skilled in the art to be suitable for the purpose. As described above, the first core frame 109 forms an enclosed area once assembled.

In one embodiment of the invention, a second core frame 117 is assembled in the same fashion as the first core frame 109. In other embodiments of the invention, there may be yet additional core frames assembled in a similar fashion as the first core frame 109. In all embodiments of the invention that employ multiple core frames, the overall length and width of the respective core frames is substantially similar.

In one embodiment of the invention that employs a single core frame, the method now progresses to the next step. However, in other embodiments of the invention that employ multiple core frames another step is performed. In such an embodiment, the multiple core frames are assembled atop each other and fastened together with a fastening means, thereby forming a single core frame. The fastening means may comprise staples, nail, threaded fasteners, adhesives, or any other fastening means that is known to one skilled in the art to be suitable for the purpose.

A top skin panel 102 is formed in a length and width substantially similar to that of the first core frame 109. The top skin panel 102 has an inner and outer surface, the inner surface being obscured from view once the lightweight composite panel 100 is assembled and the outer surface being viewable by the end user. A bottom skin panel 104 is formed in a length and width substantially similar to that of the first core frame 109. The bottom skin panel 104 has an inner and outer surface, the inner surface being obscured from view once the lightweight composite panel 100 is assembled and the outer surface being viewable by the end user. The materials from which the top skin panel 102 and bottom skin panel 104 may be formed are discussed above.

A lightweight material 106 is then formed in a shape of approximate equal length and width of the enclosed area created by the first core frame 109. In an embodiment that employs only a first core frame 109, the lightweight material is of approximate equal thickness of the first core frame 109. In embodiments of the invention that employ the first core frame 109 and second core frame 117, or additional core frames, the thickness of the lightweight material 106 is equal to the combined thickness of the multiple core frames. In an embodiment that employs only a first core frame 109, the lightweight material 106 is then placed within the enclosed area of the first core frame 109. In alternative embodiments of the invention that employ the first core frame 109 and second core frame 117, or additional core frames, the lightweight material 106 is placed within the enclosed area of the multiple core frames. The lightweight material positioned within the enclosed area of the core frames then forms what will be referred to as a core frame and lightweight material assembly. The lightweight material assembly has a top and bottom side.

An adhesive is applied to the top and bottom side of the core frame and lightweight material assembly. An adhesive is applied to the inner surface of the top skin panel 102 and the inner surface of the bottom skin panel 104. In one embodiment of the invention, the adhesive applied may be of the type that is cured through the application of heat. In an alternative embodiment of the invention, the adhesive applied may be of the type that is cured through the application of electromagnetic energy. In embodiments of the invention that utilize an additional panel placed between the first core frame 109 and the top skin panel 102 or between the bottom skin panel 104 and second core frame 117, adhesive may be applied on either side of the additional panel. In embodiments of the invention that makes use of an additional panel placed between the top skin panel 102 and the first core frame 109, adhesive may not be applied to the top skin panel 102. In other embodiments of the invention that utilize an additional panel placed between the bottom skin panel 104 and the second core frame 117, adhesive may not be applied to the bottom skin panel 104. In an alternative embodiment, a fastener means is used to fasten the top skin panel 102 and bottom skin panel 104 to the core frame and lightweight material assembly. The fastener means may comprise any suitable fastening means that is known to one skilled in the art to be suitable for the purpose.

The core frame and lightweight material assembly is then positioned on top of the inner surface of the bottom skin panel 104. The inner surface of the top skin panel 102 is then positioned on top of the core frame and lightweight material assembly.

The bottom skin panel 104, core frame and lightweight material assembly, and top skin panel 102 are then positioned in a press 126. In one embodiment of the invention, the press 126 broadly includes a mold base 130 and an upper mold half 128, along with a mechanical or hydraulic structure that presses the mold base 130 and upper mold half 128 together. The mold base 130 and upper mold half 128 have a curved contour about their longitudinal axis, with a substantially similar radius. The curved contour of the mold base 130 and upper mold half 128 is readily apparent in the embodiment of the invention depicted in FIG. 4. Although not depicted in FIG. 4, alternative embodiments of the invention may use a mold base 130 and upper mold half 128 that are shaped in a manner as to form the lightweight composite panel 100 in a compound curved shape. Additionally, the lightweight composite panel 100 could be formed in a substantially flat shape with the appropriately shaped mold base 130 and upper mold half 128. The upper mold half 128 of the press 126 is then pressed down, towards the mold base 130 through the application of force in the same direction. This pressing operation presses the bottom skin panel 104, core frame and lightweight material assembly, and top skin panel 102 into the mold base 130, and forces them to be formed into a contoured shape substantially similar to that of the mold base 130 and upper mold half 128. In alternative embodiments, the mold base 130 and upper mold half 128 may not have a curved contour, and instead may be substantially flat. As would be understood by those of skill in the art, other shapes and contours could also be formed with an appropriate mold.

In embodiments that employ an adhesive cured through the application of heat, the pressing process may include the additional step of heating the components of the lightweight composite panel 100 in order to cure the adhesive. This may be accomplished through the heating of the press 126, mold base 130, or upper mold half 128 by various methods well known in the art. In embodiments that employ an adhesive cured through the application of electro magnetic energy the pressing process may include the additional steps of applying electro magnetic energy to the components of the lightweight composite panel 100 in order to cure the adhesive. This may be accomplished through various methods well known in the art.

The present invention has been described in relation to particular embodiments, which are intended in all respects to be illustrative rather than restrictive. Alternative embodiments will become apparent to those skilled in the art to which the present invention pertains without departing from its scope.

It will be seen from the foregoing that this invention is one well adapted to attain the ends and objects set forth above, and to attain other advantages, which are obvious and inherent in the device. It will be understood that certain features and subcombinations are of utility and may be employed without reference to other features and subcombinations. This is contemplated by and within the scope of the claims. It will be appreciated by persons skilled in the art that the present invention is not limited to what has been particularly shown and described hereinabove. Rather, all matter herein set forth or shown in the accompanying drawings is to be interpreted as illustrative and not limiting.

1. A method of manufacturing a lightweight composite panel, the method comprising the steps of:
assembling at least one core frame forming a bounded two-dimensional area, said at least one core frame having an inner surface and an outer surface;
positioning within said bounded area a lightweight material in a shape of approximate equal length and width of the bounded two-dimensional area of the at least one core frame and approximate equal thickness of the at least one core frame;
placing a top skin panel of substantially the same length and width as the core frame on top of the core frame and lightweight material assembly; said placing including application of an adhesive between the top and bottom skin panels and the core frame and lightweight material assembly;
placing the bottom skin panel, core frame and lightweight material assembly, and top skin panel into a mold;
pressing said top skin panel, said bottom skin panel, and said core frame and lightweight material assembly in the mold, whereby said panels and assembly conform to the shape of the mold to form a lightweight composite panel; and
removing the lightweight composite panel from the mold.

2. The method of manufacturing a lightweight composite panel of claim 1, wherein a plurality of core frames of substantially similar length and width are assembled atop each other to form a single core frame.

3. The method of manufacturing a lightweight composite panel of claim 2, wherein the plurality of core frames are fastened together to form the single core frame.

4. The method of manufacturing a lightweight composite panel of claim 3, wherein the plurality of core frames are fastened together with an adhesive.

5. The method of manufacturing a lightweight composite panel of claim 1, wherein the at least one core frame is formed from a plurality of flat members coupled by way of a fastener means.

6. The method of manufacturing a lightweight composite panel of claim 1, wherein the core frame is assembled from flat members having substantially similar properties as the top and bottom skin panels.

7. The method of manufacturing a lightweight composite panel of claim 1, wherein the lightweight material substantially fills the cavity bounded by the top skin panel, bottom skin panel, and at least one core frame.

8. The method of manufacturing a lightweight composite panel of claim 1, wherein the lightweight material is a form of polystyrene.

9. The method of manufacturing a lightweight composite panel of claim 8, wherein the form of polystyrene is expanded polystyrene foam.

10. The method of manufacturing a lightweight composite panel of claim 1, wherein the adhesive applied to the top and bottom skin panels and core frame and lightweight material assembly is an adhesive cured through the application of heat.

11. The method of manufacturing a lightweight composite panel of claim 1, wherein the adhesive applied to the top and bottom skin panels and core frame and lightweight material assembly is an adhesive cured through the application of electro magnetic energy.

12. The method of manufacturing a lightweight composite panel of claim 1, wherein the mold has a base and an upper mold half that are curved about the same longitudinal axis.

13. A lightweight composite panel comprising:
at least one core frame forming a bounded two-dimensional area;
a lightweight material of substantially similar thickness of the core frame and of substantially similar length and width of the bounded two-dimensional area, said lightweight material positioned within the core frame to form a lightweight core frame assembly having a top side and a bottom side;
a top skin panel of substantially similar length and width as the lightweight core frame assembly, fastened to the top side of the lightweight core frame assembly;
a bottom skin panel of substantially similar length and width as the lightweight core frame assembly, fastened to the bottom side of the lightweight core frame assembly;
whereby the top skin panel, bottom skin panel, and lightweight core frame assembly form a lightweight composite panel.

14. The lightweight composite panel of claim 13, wherein a plurality of core frames of substantially similar length and width are assembled atop each other and fastened together to form a single core frame.

15. The lightweight composite panel of claim 13, wherein the core frame is formed from a plurality of flat members having substantially similar properties as the top and bottom skin panels.

16. The lightweight composite panel of claim 13, wherein the lightweight material is of a size and shape as to substantially fill the cavity bounded by the top skin panel, the bottom skin panel, and the at least one core frame

17. The lightweight composite panel of claim 13, wherein the lightweight material is a form of polystyrene.

18. The lightweight composite panel of claim 17, wherein the lightweight material is expanded polystyrene foam.

19. The lightweight composite panel of claim 13, wherein the top and bottom skin assembly are fastened to the lightweight core frame assembly with an adhesive.

20. The lightweight composite panel of claim 19, wherein the adhesive applied to the top and bottom skin panels and core frame assembly is an adhesive cured through the application of heat.

21. The lightweight composite panel of claim 19, wherein the adhesive applied to the top and bottom skin panels and core frame assembly is an adhesive cured through the application of electro magnetic energy.
